(19) United States
(12) Patent Application Publication
(10) Pub. No.: US 2003/0045302 A1
(43) Pub. Date: Mar. 6, 2003

(54) Mobile communication system and program for specifying location of terminal unit

(75) Inventors: Kyoji Oda, Gamagori-city (JP); Tatsuya Shintai, Chita-gun (JP); Atsushi Hayashida, Kariya-city (JP); Hiroyasu Ogino, Okazaki-city (JP); Toshihiro Takeuchi, Tokoname-city (JP); Michio Shamoto, Niwa-gun (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 10/224,351

(22) Filed: Aug. 21, 2002

(30) Foreign Application Priority Data
Aug. 31, 2001 (JP) 2001-264242

(51) Int. Cl. H04Q 7/20

(52) U.S. Cl. 455/456; 455/422

(57) ABSTRACT

In a mobile communication system, a terminal unit makes access to surrounding base stations to get base station information and sends the information together with self terminal information to a location server. The terminal unit receives assistant information for the reception of GPS satellite signals from the location server and measures the GPS signals and signal delay values of base stations. The terminal unit location is computed based on the signal delay value data selected as being smaller than a threshold value or as being smallest delay values.

### CROSS REFERENCE TO RELATED APPLICATION

This application is based on and incorporates herein by reference Japanese Patent Application No. 2001-264242 filed on Aug. 31, 2001.

### FIELD OF THE INVENTION

The present invention relates to a mobile communication system including a terminal unit, which communicates with base stations through wireless links and is particularly capable of finding the location of itself.

### BACKGROUND OF THE INVENTION

A communication network such as a cellular phone network performs the location specifying of mobile communication terminal units based on base station information received by the terminal units. In the communication network of CDMA (Code Division Multiple Access) scheme, for example, each mobile terminal unit receives signals from base stations having the assignment of PN (Pseudo Noise) codes as spread codes, and implements the de-spreading process for the signals with the received PN codes.

The base stations and mobile terminal units operate synchronously based on the system clock signal, and the correlation peak resulting from the de-spreading process occurs at the time points determined for the individual PN codes. The occurrence of correlation peak actually has a delay by the signal propagation time from each base station. The mobile terminal unit measures the signal delay values of the base stations and sends the delay value data as base station information, with the corresponding PN codes being attached, to a location server. The location server computes the location of the terminal unit based on the received base station information. The terminal unit receives the computed location information from the location server to find its location.

The location specifying process requires a complicated computation based on registered information of base stations (identification codes, locations, communication frequencies, antenna directivities, etc.). The mobile terminal unit does not implement the location specifying computation by itself. It collects information necessary for the location computation implemented by the location server in the communication system.

The measured signal delay value of each base station which is the key information for the computation of terminal unit location represents the distance from the base station to the terminal unit, i.e., a large signal delay value signifies a long signal propagation distance for the radio-wave signal from the base station to the terminal unit. In an urban area where many tall buildings stand, the radio-wave signal reflects several times on buildings before it reaches the destined terminal unit, resulting in a practical propagation distance which is significantly longer than the direct distance from the base station to the terminal unit.

FIG. 3 shows four buildings standing nearby a base station BS and a terminal unit (mobile station) MS. In this case, the radio-wave signal cannot go straight between the base station BS and the terminal unit MS, but the signal reaches the destination by reflecting several times on the buildings to form a propagation path (shown by the solid line) which is significantly longer than the direct distance (shown by the dashed line) between the base station BS and the terminal unit MS. On this account, the conventional location specifying scheme, which bases the computation of distance between a base station and a terminal unit on the multi-reflection signal propagation time (propagation distance), is susceptible to the distance measurement error and thus problematic in the lack of accuracy of terminal unit location specifying.

### SUMMARY OF THE INVENTION

It is an object of the present invention to provide a scheme of minimizing the location specifying error which arises in the computation of mobile terminal unit location based on base station information.

According to the present invention, a mobile communication terminal unit communicates with base stations of a communication network, collects location computation information which includes at least signal delay values from the base stations to the terminal unit, sends the collected information to the communication network by which terminal unit location information is computed based on the location computation information sent from the terminal unit, and receives the computed location information from the communication network. The terminal unit or a location server of the communication network selects data of signal delay values that are smaller than a prescribed threshold value or one of the smallest delay values out of the collected signal delay value data so that only these selected signal delay value data are used as the location computation information for location computation.

### BRIEF DESCRIPTION OF THE DRAWINGS

The above and additional objects, features and advantages of the present invention will become more apparent from the following detailed description made with reference to the accompanying drawings. In the drawings:

FIG. 1 is a schematic diagram showing a communication system;

FIG. 2 is a block diagram showing a mobile communication terminal unit used in the communication system shown in FIG. 1;

FIG. 3 is a schematic diagram showing a multi-reflection path of a radio-wave signal reflected by buildings standing between a base station and a mobile station;

FIG. 4 is a flowchart showing an information collecting operation in the idling state of the mobile communication terminal unit in the first embodiment of the present invention;

FIG. 5 is a flowchart showing a location specifying operation of the mobile communication terminal unit in the first embodiment of the present invention; and

FIG. 6 is a flowchart showing a location specifying operation of the location server in the second embodiment of the present invention.

### DETAILED DESCRIPTION OF THE PREFERRED EMBODIMENTS

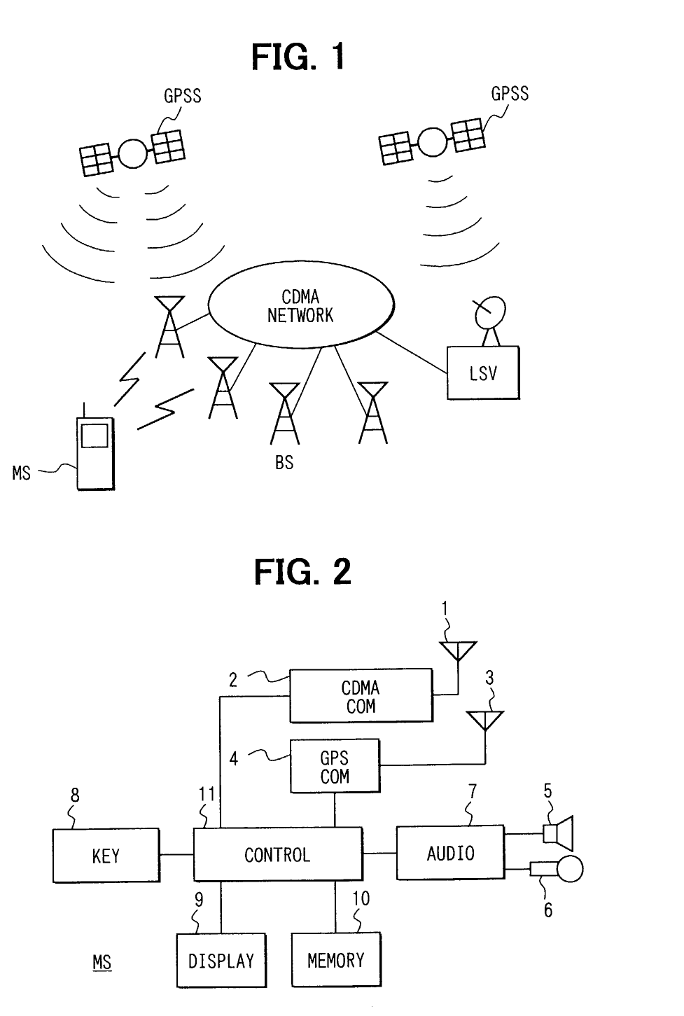

Referring first to FIG. 1 showing a CDMA communication network, a mobile communication terminal unit MS communicates with base stations BS which are linked to the CDMA network. A location server LSV is further linked to the CDMA network. The location server LSV is designed to compute the terminal unit location based on information collected and sent by the terminal unit MS. The base stations BS and location server LSV have their operational clocks synchronized with GPS signals received from GPS satellites GPSS. The terminal unit MS receives the GPS signals, and sends location computation information carried by the GPS signals to the location server LSV via the CDMA network.

As shown in FIG. 2, the mobile communication terminal unit MS includes a CDMA antenna 1 and a CDMA communication device 2 which are used for the CDMA communication with the base stations BS, a GPS antenna 3 and a GPS communication device 4 which are used to receive the GPS signals from the GPS satellites, a speaker 5, a microphone 6 and an audio processor 7 which are used for the audio interaction with the terminal user, a key panel 8 which is operated by the terminal user, a display panel 9 which is used to display various information for the terminal user, a memory 10 which stores a program and data, and a controller 11 which runs the program and controls the operation of these internal devices. The controller 11 can be a microcomputer. The key panel 8 and display panel 9 can be a combined touch-panel device. The CDMA antenna 1 and the GPS antenna 3 can be a common antenna.

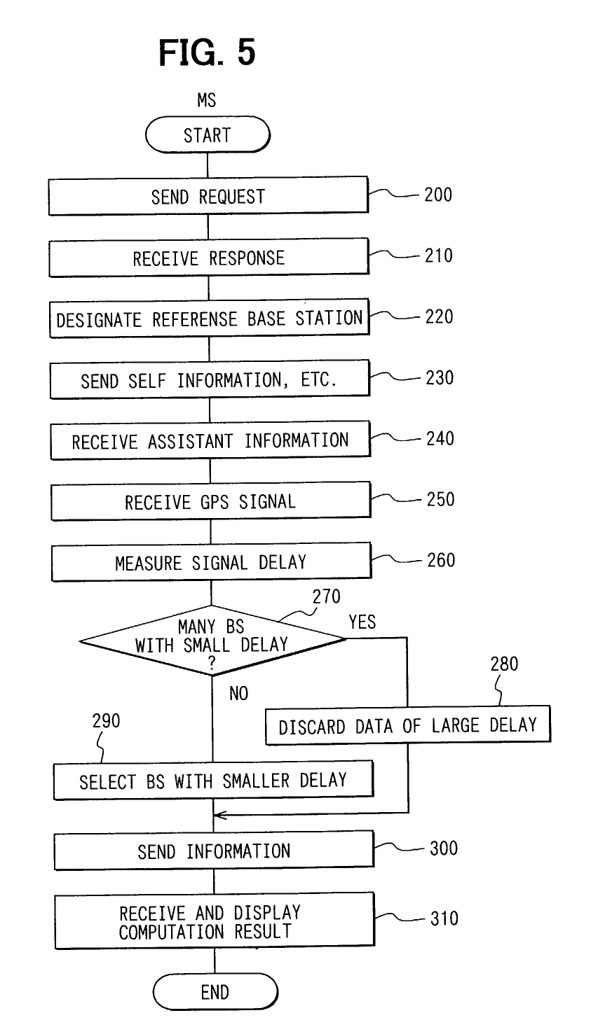

Next, the operation of the terminal unit MS implemented by its computer-based controller will be explained with reference to the flowcharts of FIG. 4 and FIG. 5.

A PN code is a spread code of the CDMA scheme, and a maximum of 512 codes are assigned to base stations BS. The terminal unit MS operating in synchronism with the base stations BS identifies each base station based on the time length (phase difference) from the head of the first cycle of the PN code signal until the occurrence of correlation peak in the de-spreading process with the received PN code. The signal delay is caused in correspondence with the propagation time of the PN code signal from a base station to the terminal unit.

The computation of terminal unit location implemented by the location server LSV takes place generally as follows. The location server LSV makes access to the database by use of PN codes to get the latitudes and longitudes of base stations based on the PN codes, signal delay values and GPS signals (satellite numbers and reception times) of the reference base station having the smallest signal delay value (the base station nearest to the terminal unit MS) and other surrounding base stations, computes the distances between the base stations and the terminal unit based on signal delay values of the other base stations relative to the signal delay value of the reference base station, computes the distances between the GPS satellites and the terminal unit MS based on the GPS satellite numbers and reception times, and determines the location of the terminal unit MS from the computed distances based on the triangulation.

As shown in FIG. 4, in the idling state (wait state) of the terminal unit MS, i.e., when it has just been turned on or it is not communicating, the terminal unit MS makes access to surrounding base stations BS thereby to designate a base station of the highest contact signal level to be the serving base station (step 100). The terminal unit MS receives the signal from the serving base station through the paging channel thereby to acquire overhead information (step 110).

The overhead information includes the PN code and ID code of the serving base station, positional information (latitude and longitude) of the serving base station, available frequencies, a list of surrounding base stations, and a network ID number. The terminal unit MS receives the overhead information cyclically to keep the latest information during the idling state. In case the latest neighbor list does not contain surrounding base stations, as in the case when the terminal unit MS is turned on after a long distance movement, the terminal unit MS makes access to base stations in the order of PN codes, designates a first-contact base station to be the serving base station, gets the overhead information from it, and enters the information updating cycle shown in FIG. 4 in the idling state.

Next, the operation of the terminal unit MS to collect location computation information will be explained with reference to the flowchart of FIG. 5.

When the terminal unit MS is instructed by the user's key operation to find its location, it starts the information collection operation of FIG. 5. The terminal unit MS sends a request signal of location specifying to the communication network unless it is outside the range of communication with base stations (step 200).

Upon receiving a response signal against the location specifying request from the location server LSV through the network (step 210), the terminal unit MS makes access to surrounding base stations based on the neighbor list, designates a base station with the smallest signal delay value to be the reference base station based on the reception results of radio-wave signals from the base stations, and stores the PN codes and data of signal delay values of the reference base station and other surrounding base stations as base station information in the memory 10 (step 220). Selection of a base station with the smallest signal delay value is for the designation of a base station that is nearest to the terminal unit MS to the reference base station. The signal delay value of each base station can be a relative delay value with respect to the signal delay value of the reference base station.

At the next step 230, the terminal unit MS sends self terminal information and the obtained base station information (the PN code and signal delay value data of the reference base station and the PN codes and relative delay value data of other surrounding base stations) to the location server LSV.

The location server LSV determines the approximate location of the terminal unit MS based on the received information, and sends GPS satellite numbers and associated access parameters relevant to the determined approximate location as location specifying assistant information to the terminal unit MS. The terminal unit MS receives the assistant information (step 240).

The terminal unit MS receives the GPS signals from the GPS satellites based on the assistant information and finds signals with reception signal levels above a threshold value (step 250). The terminal unit MS measures the signal delay values of surrounding base stations again for updating (step 260).

At the next step 270, the terminal unit MS compares the collected signal delay values of base stations with a predetermined threshold value thereby to determine whether or not the number of base stations with signal delay values that are smaller than the threshold value is more than or equal to a first prescribed number, e.g., 5. The threshold value is set for the comparison with the relative delay values of base stations with respect to the delay value of the reference base station. Specifically, for example, when the threshold value is set to be 16.3 μs which is equivalent to a signal propagation distance of about 5 km, this step discriminates base stations that are within a circle having its center at the terminal unit MS and a radius equal to the distance between the terminal unit MS and the reference base station plus 5 km. Accordingly, based on the setting of threshold value against relative signal delay values, it is possible to discriminate base stations within the distance of reference base station from the terminal unit MS plus the threshold value irrespective of the distance between the terminal unit MS and the reference base station. Alternatively, the threshold value may be set against absolute signal delay values which are equivalent to the signal propagation times to the terminal unit MS.

If the number of base stations with signal delay values that are smaller than the threshold value is the first prescribed number of 5 or more, step 280 discards delay value data over the threshold value. Otherwise, if it is less than the first prescribed number of 5, step 290 selects a second prescribed number, e.g., 5, of data in the ascending order of delay values and discards remaining data.

The first prescribed number for the determination of the number of base stations with signal delay values that are smaller than the threshold value and the second prescribed number for the selection of data in the ascending order of delay values are determined depending on the accuracy of location specifying required. The number of delay value data necessary for the computation of location specifying based on the triangulation is 3 at minimum, however, four pieces of data are used to have a fairly good accuracy in general. The higher the accuracy of location specifying required, the larger are the first and second prescribed numbers to be set. In case GPS signals are obtained at step 250, the number of delay value data may be reduced by the number of GPS signals (e.g., from 5 to 3 in case two GPS signals are already obtained). The number of data to be selected depending on the GPS signals can be altered on the part of the location server at the computation of location specifying.

In case the number of data of measured signal delay values is less than the second prescribed number of 5, all data are selected in step 290.

At step 300, the terminal unit MS sends location specifying information including the GPS signals measured in step 250, data which have not been discarded in steps 280 and 290, i.e., PN codes of base stations and their signal delay value data together with information of the self terminal unit to the location server LSV. The location server LSV computes the terminal unit location based on the received location specifying information and sends the computation result back to the terminal unit MS. The terminal unit MS receives the result of location computation from the location server LSV and displays on the display device 9 (step 310).

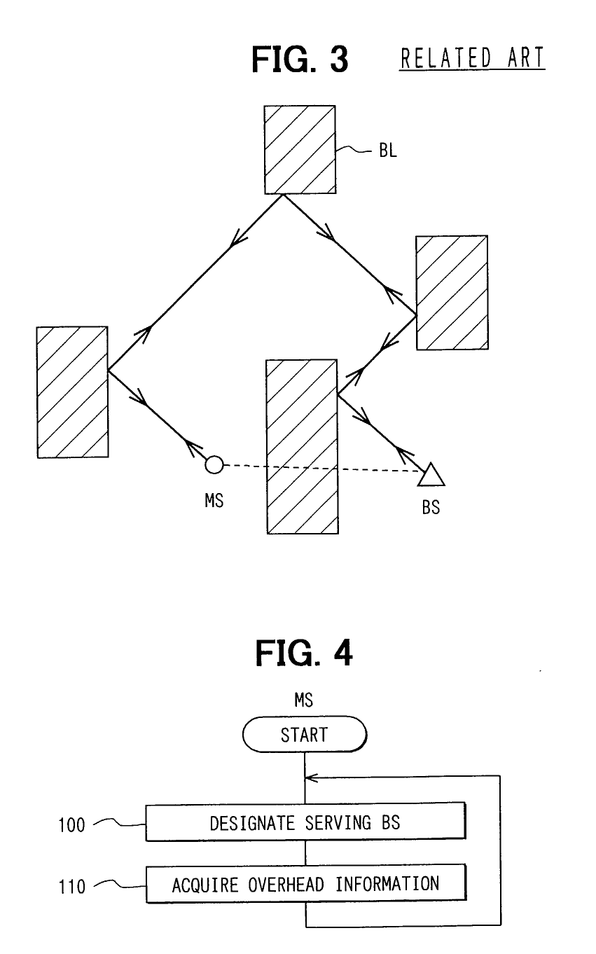

In the mobile communication terminal unit of the first embodiment, data of signal delay values larger than the threshold value out of base station information necessary for the computation of terminal unit location is discarded and only data of smaller signal delay values is sent selectively to the location server through the communication network. Thus, it is possible to reject information resulting from signal propagation distances longer, due to multi-reflection paths by buildings BL (FIG. 3), than the direct distance between the base stations and the terminal unit, and consequently it is possible for the location server to minimize the location specifying error.

The mobile communication terminal unit of the first embodiment selects signal delay values based on the comparison with a threshold value. Even if the number of data of delay values that are smaller than the threshold value is less than a first prescribed number (e.g., 5), it selects a maximum of a second prescribed number of data in the ascending order of delay values, whereby a location specifying result with a fairly good accuracy can be attained even in an inferior reception condition of the mobile terminal unit.

The operation program which is run by the mobile communication terminal unit of the first embodiment may be stored in the memory 10 in advance, or may be circulated in the communication network and received by the terminal unit at the time of operation.

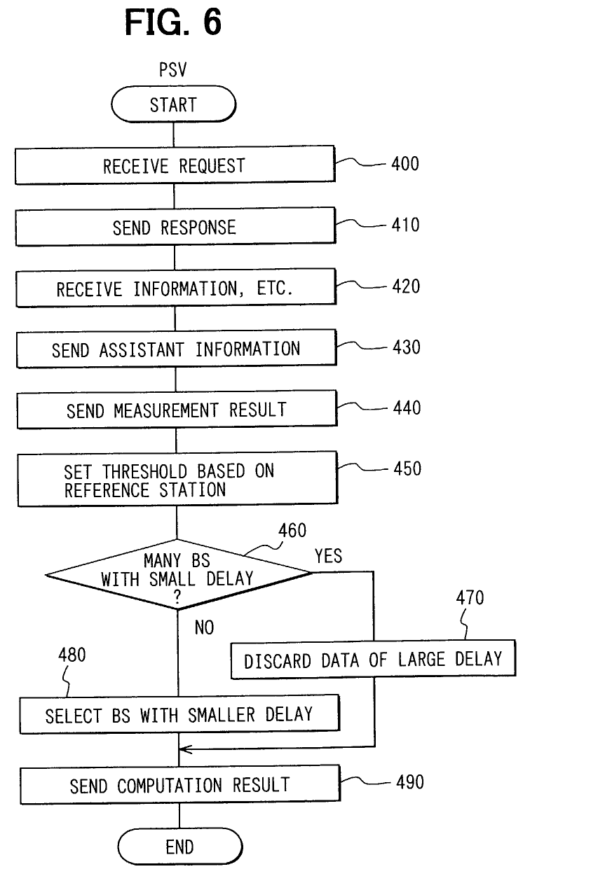

The second embodiment differs from the first embodiment in that the terminal unit MS sends all base station information collected for location computation to the location server LSV, by which data of smaller signal delay values are selected and the rest is discarded. The following explains the operation of the location server LSV with reference to the flowchart of FIG. 6.

The location server LSV receives a request signal of location specifying from the terminal unit MS (step 400), and sends a response signal back to the terminal unit MS (step 410). The terminal unit MS operates in the same manner as in the first embodiment to make access to surrounding base stations based on the neighbor list, designate a base station with the minimum signal delay value to be the reference base station, and send the PN code and data of signal delay value of the reference base station together with information of the self terminal unit to the location server LSV.

Upon receiving the location computation information from the terminal unit MS (step 420), the location server LSV determines the approximate location of the terminal unit MS and sends GPS satellite numbers and associated access parameters relevant to the determined approximate location as location specifying assistant information to the terminal unit MS (step 430).

The terminal unit MS measures the GPS signals from the GPS satellites based on the assistant information, measures the signal delay values of surrounding base stations again for updating, and sends the resulting information to the location server LSV.

Upon receiving the location computation information (step 440), the location server LSV sets a threshold value relevant to the reference base station which has been selected as the nearest base station by the terminal unit MS (step 450). The threshold value has been set and stored in advance depending on the location of the reference base station. Specifically, the threshold value can be set smaller in case the reference base station is in an area with crowded buildings (particularly tall buildings), or set larger in proportion to the rareness of buildings. Alternatively, the threshold value can be set smaller for an urban area where base stations have small cell areas, or set larger for a suburban area where base stations have large cell areas.

At the next step 460, the location server LSV compares the signal delay values of base stations provided by the terminal unit MS with the threshold value set at step 450 thereby to determine whether or not the number of base stations with signal delay values that are smaller than the threshold value is more than or equal to the first prescribed number, e.g., 5, as in the case of the first embodiment.

If the number of base stations with signal delay values that are smaller than the threshold value is the first prescribed number or more, step 470 discards delay value data over the threshold value. Otherwise, if it is less than the first prescribed number, step 480 selects a maximum of the second prescribed number of 5 of data in the ascending order of delay values and discards remaining data.

At the next step 490, the location server LSV computes the terminal unit location based on the signal delay values and corresponding PN codes of base stations which have not been discarded and information of self terminal unit, and sends the computation result to the terminal unit MS.

In the second embodiment, the location server LSV computes the terminal unit location by selecting data of smaller signal delay values out of location computation information provided by the terminal unit MS, while discarding data of larger delay values, whereby it is possible to reject information resulting from signal propagation distances longer, due to multi-reflection paths by buildings, than the direct distance between the base stations and the terminal unit. Consequently it is possible to minimize the location specifying error as in the case of the first embodiment.

In the second embodiment, the location server LSV selects signal delay values based on the comparison with a threshold value, and even if the number of data of delay values that are smaller than the threshold value is less than a first prescribed number (e.g., 5), it selects a maximum of a second prescribed number of data, whereby a location specifying result with a fairly good accuracy can be attained even in a poor reception condition of the terminal unit MS.

It is possible for the communication system of the second embodiment to set a smaller threshold value for the assessment of signal delay values collected by the terminal unit MS in case the reference base station is in an area with crowded buildings or in a small cell area, or set a larger threshold value in case the reference base station is in an area of rare buildings or in a large cell area, whereby it is possible to minimize the location specifying error virtually constantly irrespective of the location of the terminal unit MS.

The present invention should not be limited to the disclosed embodiments, but may be implemented in various other ways without departing from the spirit of the invention.

What is claimed is:

1. A mobile communication terminal unit for communication with base stations of a communication network through wireless communication links, the terminal unit comprising:
means for collecting location computation information which includes at least signal delay values from the base stations to the terminal unit and is necessary for the computation of terminal unit location;
means for sending the collected information to the communication network by which the terminal unit location information is computed based on the location computation information sent from the terminal unit; and
means for receiving the computed location information from the communication network,
wherein the sending means selects data of signal delay values that are smaller than a prescribed threshold value out of the collected signal delay value data and sends only the selected signal delay value data as the location computation information to the communication network.

2. A mobile communication terminal unit for communication with base stations of a communication network through wireless communication links, the terminal unit comprising:
means for collecting location computation information which includes at least signal delay values from the base stations to the terminal unit and is necessary for the computation of terminal unit location;
means for sending the collected information to the communication network by which the terminal unit location information is computed based on the location computation information sent from the terminal unit; and
means for receiving the computed location information from the communication network,
wherein the sending means selects a prescribed number of data of smallest delay values out of the collected signal delay value data and sends the selected signal delay value data as the location computation information to the communication network.

3. The mobile communication terminal unit as in claim 1, wherein the signal delay values are relative delay values with respect to a reference signal delay value of a reference base station.

4. The mobile communication terminal unit as in claim 1, wherein when the number of data of signal delay values that are selected as being smaller than the prescribed threshold value is less than a first prescribed number, the selecting means selects a second prescribed number of data of smallest delay values out of the collected signal delay value data.

5. An operation program which is run by a computer of a mobile communication terminal unit which communicates with base stations of a communication network through wireless communication links, the program comprising parts of causing the computer to execute steps of:
collecting location computation information which includes at least signal delay values from the base stations to the terminal unit and is necessary for the computation of terminal unit location;
selecting data of signal delay values that are smaller than a prescribed threshold value out of the collected signal delay value data and sending only the selected signal delay value data as the location computation information to the communication network; and
receiving terminal unit location information resulting from the computation by the communication network based on the location computation information sent from the terminal unit.

6. An operation program which is run by a computer of a mobile communication terminal unit which communicates with base stations of a communication network through wireless communication links, the program comprising parts of causing the computer to execute steps of:
collecting location computation information which includes at least signal delay values from the base stations to the terminal unit and is necessary for the computation of terminal unit location;
selecting a prescribed number of data of smallest delay values out of the collected signal delay value data and sending only the selected signal delay value data as the location computation information to the communication network; and
receiving terminal unit location information resulting from the computation by the communication network based on the location computation information sent from the terminal unit.

7. The operation program as in claim 6, wherein the signal delay values are relative delay values with respect to a reference signal delay value of a reference base station.

8. The operation program as in claim 5, wherein in case the number of data of signal delay values that are smaller than the prescribed threshold value is less than a first prescribed number, a second prescribed number of data of smallest delay values are selected as the location computation information.

9. A location server which forms a communication network with base stations and a mobile communication terminal unit which communicates with the base stations through wireless communication links, the location server comprising:
means for receiving location computation information which includes at least signal delay values from the base stations to the terminal unit, is collected and sent by the terminal unit and is necessary for the computation of terminal unit location;
means for computing the terminal unit location based on the received location computation information; and
means for sending a computation result to the terminal unit,
wherein the computing means includes means for selecting data of signal delay values that are smaller than a prescribed threshold value out of the signal delay value data included in the location computation information sent from the terminal unit so that the terminal unit location is computed based on the selected signal delay values.

10. A location server which forms a communication network with base stations and a mobile communication terminal unit which communicates with the base stations through wireless communication links, the location server comprising:
means for receiving location computation information which includes at least signal delay values from the base stations to the terminal unit, is collected and sent by the terminal unit and is necessary for the computation of terminal unit location;
means for computing the terminal unit location based on the received location computation information; and
means for sending a computation result to the terminal unit,
wherein the computing means includes means for selecting a prescribed number of data of smallest delay values out of the signal delay value data included in the location computation information sent from the terminal unit so that the terminal unit location is computed based on the selected signal delay values.

11. The location server as in claim 9, wherein the signal delay values are relative delay values with respect to a reference signal delay value of a reference base station.

12. The location server as in claim 9, wherein in case the number of data of signal delay values that are smaller than the prescribed threshold value is less than a first prescribed number, the selecting means selects a second prescribed number of data of smallest delay values as the location computation information.

13. The location server as in claim 9, wherein the threshold value is set in advance depending on each area from which the terminal unit sends the location computation information.

14. A method of mobile communication between a mobile communication terminal unit and a communication network including base stations, the method comprising steps of:
collecting, by the terminal unit, location computation information which includes at least signal delay values from the base stations to the terminal unit and is necessary for the computation of terminal unit location;
selecting a part of data of signal delay values out of the collected signal delay value data and sending only the selected signal delay value data as the location computation information to the communication network, the selected signal delay values being smaller than a prescribed threshold value or smallest;
computing, by the communication network, the terminal unit location based on the selected signal delay values; and
indicating, by the terminal unit, the computed terminal unit location.

15. The method as in claim 14 further comprising a step of:
sending, by a location server of the communication network, assistant information which specifies GPS satellites.

16. The method as in claim 14 further comprising steps of:
receiving, by the terminal unit, GPS signals from the specified GPS satellites;
measuring signals having intensity of more than a prescribed level out of the received GPS signals; and
sending a result of the measuring step to the location server.

17. The method as in claim 16 further comprising a step of:
updating the signal delay values of the base stations based on the assistant information.

18. The method as in claim 14 further comprising steps of:
setting the threshold value to different values based on a location of a reference station that is determined to be a closest one among the base stations by the terminal unit.

19. The method as in claim 18, wherein the threshold value is set to a smaller value as the reference station is located in an area crowded with buildings.

20. The method as in claim 18, wherein the threshold value is variable with a communication area of the reference station.
